(19) United States
(12) Patent Application Publication
(10) Pub. No.: US 2009/0296608 A1
(43) Pub. Date: Dec. 3, 2009

(54) CUSTOMIZED ROUTING TABLE FOR CONFERENCING

(75) Inventors: Humayun Khan, Redmond, WA (US); Jiannan Zheng, Sammamish, WA (US); Mahathi Mahabhashyam, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/129,673

(22) Filed: May 29, 2008

(51) Int. Cl. H04L 12/16

(52) U.S. Cl. 370/260

(57) ABSTRACT

Architecture employs custom routing tables that facilitate sub-conferences for the main conference session. Sub-conferences in a Voice over IP (VoIP) or Audio/Video over IP (A/VoIP) conference can be created with overlapping sets of sources contributing to overlapping sets of sinks. The custom routing table architecture allows the subdividing of the main routing table into smaller virtual subtables and the configuration of the subtables individually using different corresponding rulesets. These subtables are referred to as groups or conference groups. Each group has a ruleset which defines the routes between sources and sinks of the group. Each source or sink can belong to two or more groups. Thus, the subtables can overlap. Groups and the corresponding rulesets together provide a new way to customize the overall routing configurations in the conference.

### BACKGROUND

Conferencing is becoming an increasingly popular tool for joining users from disparate locations into communication sessions to collaborate on common goals. Moreover, the conferencing systems allow users to join in many different ways. For example, one user may join an audio channel of the session using a phone, while another user joins the session video stream, and yet others can join the session using both the audio and video streams. Users may join via IP networks, cellular systems, and landline networks.

In support of audio and video conferencing, media streams are routed between sources and sinks. The conference content in the form of audio and/or video generated needs to be routed to each audio and/or video sink. This is accomplished using routing tables that provide a matrix of connections between the sources and the sinks. When the conferencing system receives content from source endpoints, the current states of the routing table provides the mapping for routing the content to the desired sink endpoints. This is performed at a session level. The conferencing system generates and changes the routing table based on the dynamic changes in session participation. For example, when the session is operating and a new user joins the session, the routing table is updated to facilitate participation in the session by the user. Similarly, when a participant leaves the session, the routing table is updated to remove that user as an endpoint.

However, these conventional conferencing systems lack the ability to support more granular control in the session. For example, extended sessions can result in some participants not caring to expend time in listening to the current session topic, when a more productive effort for the allotted time can be better spent conferring with other session participants on a topic in parallel with current major topic.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture employs custom routing tables that facilitate sub-conferences for the main conference session. Titles provide the ability to create sub-conferences in a Voice over IP (VoIP) or Audio/Video over IP (A/VoIP) conference with overlapping sets of sources contributing to overlapping sets of sinks. By virtue of this system, differentiation among channels in the same conference and the creation of sub-conferences can be supported.

In a standard conference operating over an IP network, sources send media and sinks consume the media. A main session routing table can be configured by an application to create predefined ruleset. The custom routing table architecture allows the subdividing of the main routing table into smaller virtual subtables and the configuration of the subtables individually using different corresponding rulesets. These subtables are referred to as groups or conference groups. Each group has a ruleset which defines the routes among sources and sinks in the group. Each source or sink can belong to two or more groups. Thus, the subtables can overlap. Groups and the corresponding rulesets together provide a new way to customize the overall routing configurations in the conference.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an exemplary computer-implemented conference management system.

FIG. 2 illustrates an alternative embodiment of an exemplary conference management system.

FIG. 3 illustrates an exemplary custom routing table generated by merging conference groups.

FIG. 4 illustrates a conference system that employs the use of a personal virtual assistant (PVA) group.

FIG. 5 illustrates a conference system that employs the use of a conference announcement service group.

FIG. 6 illustrates a conference system that employs the use of a conference announcement service group.

FIG. 7 illustrates an exemplary main session routing table from which virtual routing subtables can be defined and enabled in support of breakout groups.

FIG. 8 illustrates a system that employs subtable for conferencing breakout rooms.

FIG. 9 illustrates exemplary APIs that can be provided to allow applications to access and interact with functionality of the disclosed architecture.

FIG. 10 illustrates a method of managing a conferencing session.

FIG. 11 illustrates an exemplary method for path execution when employing a personal virtual assistant.

FIG. 12 illustrates an exemplary method for path execution when further employing a conference announcement service.

FIG. 13 illustrates an exemplary method for path execution when further employing a coach scenario to the method of FIG. 11 and FIG. 12.

FIG. 14 illustrates a method of processing breakout rooms for a conferencing session.

FIG. 15 illustrates a method of processing video subscription for a conferencing session.

FIG. 16 illustrates a block diagram of a computing system operable to execute the disclosed custom routing table architecture.

### DETAILED DESCRIPTION

The disclosed conferencing architecture provides a way to customize routing configuration beyond the default rules limited to conventional systems. A grouping concept is disclosed within a conference and channels within the group have different routing behavior based on group membership. Differentiation among channels in the same conference can now be obtained. Channels can join a group as a sender, receiver or both, and routing per group is established based on the channel properties within the group. These groups are later joined to form the complete routing table for the conference.

A conference session can be abstracted as an entity that includes media sources (objects that produce media) and media sinks (objects that consume the media). The routing table is an object that describes a virtual network for connecting media sources and sinks.

The disclosed custom routing table architecture allows for the creation of conference groups within the main conference session in which sources and sinks can be added as members of the groups. Each group is controlled by a respective ruleset and by a single custom routing subtable. Sources and sinks belonging to same conference group share media (DTMF/audio/video/data) with sources sending the media and sinks consuming the media. A source can belong to two or more conference groups, and similarly, a sink can belong to two more conference groups. Moreover, the membership of the custom routing subtable is configurable from outside by external applications.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

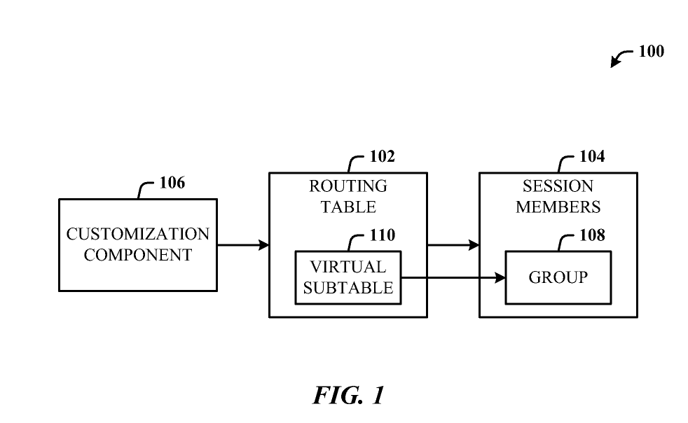

FIG. 1 illustrates an exemplary computer-implemented conference management system 100. The system 100 includes a routing table 102 of a main conferencing session for defining connections between session entities 104 for communication of media. The system 100 also includes a customization component 106 for creating a group 108 from the session entities 104 in the main conferencing session based on a virtual subtable 110 defined in the routing table 102. The main session routing table 102 defines link relationships between main session entities. The main session routing table 102 is customized by imposing group rulesets that define connections between source entities and sinks entities that form a group (or session off of the main session).

Routing table (internal to media stack) is a logical connection matrix between channels to allow/disallow media (audio and/or video) content to flow from source entities to sink entities. Each member can be a source entity (a network entity in the system that has audio and/or video stream to send) or a sink entity (a network entity in the system that has audio and/or video stream to receive). A channel is defined as an entity in the system that has an audio and/or video stream to send or an audio and/or video stream to receive. The channel is a superset of all sources and sinks. Example of channels can be audio stream coming from PSTN (public-switch telephone network) caller.

In other words, the main touting table is a connection of X sources and Y sinks. For example, a source can be the video from a webcam or the sound captured by a microphone, and the sink can be a window showing the video or the speakers on a computer. A connection between the source and the sink is a flag that can be turned on or turned off. If the flag is turned on, the source and sink can share media. The flag is controlled by one or more rules. For example, flag control can be according to a rule to turn off the flag to disconnect the source from the sink. In a more complex ruleset, two or more rules can be processed in logical combinations to determine if the flag is to be turned off or on. For example, run Rule A (send announcement to an entity or group) and Rule B (entity X is speaking). Thus all session participants, whether in the main session or groups, can be alerted to listen when a principal speaker is to present.

A group as used herein is defined as a logical collection of a subset of source entities and a subset of sink entities that share media content. A channel can join as group as source entity, sink entity, or both. Default routing rules apply within each group.

An overall (main, or main session) routing table is calculated by a media stack when a channel joins, modifies (source/sink), or leaves a group. At the time of creation of the conference, a default group is created that cannot be deleted by upper layer applications, unless the applications delete the conference. Upper layer applications can create/delete any group except the default group. A channel belongs to a group at the time of creation. By default, all channels join the default group and have to explicitly leave the default group (if required).

A session member can belong only to the main session, to the main session and a group, to the main session and more than one group, a single group, or to multiple groups. The customization component 106 removes a source/sink link of the group 108 without affecting the main conferencing session and/or session members (entities) 104. Other features are described hereinbelow.

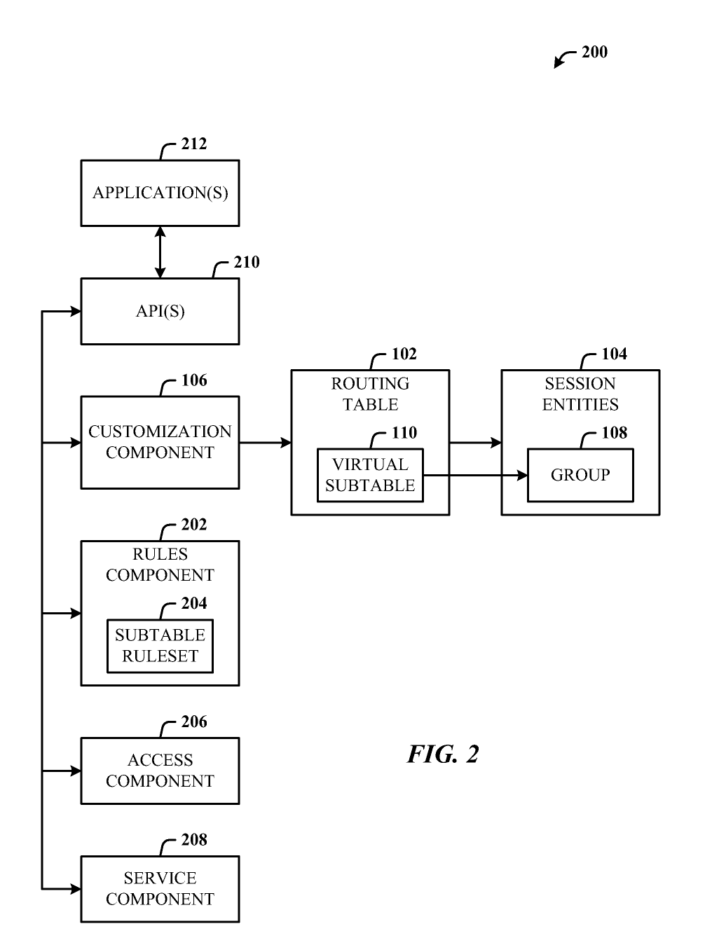

FIG. 2 illustrates an alternative embodiment of an exemplary conference management system 200. The system 200 includes the customization component 106 for creating the group 108 from the session entities 104 in the main conferencing session based on a virtual subtable 110 defined in the routing table 102. In addition, the system 200 can include a rules component 202 for generating a subtable ruleset 204 for the subtable 110 that maps connections between the group entities for communication of media.

The system 200 can further comprise an access component 206 for managing access to the conferencing session via the customization component 106. The access can be managed according to permissions such as user permission, system permissions, conference permissions, group permissions, etc.

The system 200 can further comprise a service component 208 for managing a link between the group source and sink entities according to a service agreement. The link can be managed by modifying the ruleset 204 for the virtual subtable 110.

The system 200 can further includes one or more API(s) 210 that expose underlying functionality to external applications 212. For example, the APIs 210 can include interfaces for creating a conference group, joining a channel in a group, modifying a channel in a group, removing a channel in a group, deleting a group, and listing groups to which a channel belongs. This extensibility allows other APIs to be written as desired. For example, the rules component 202 can be exposed to the external applications 212 via which the subtable ruleset 204 is generated.

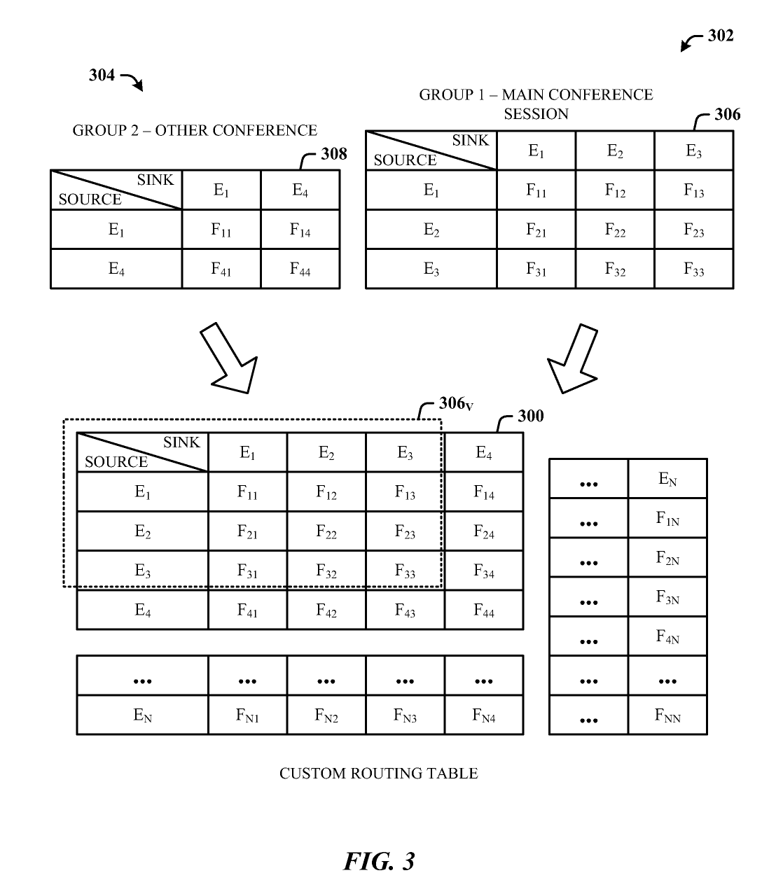

FIG. 3 illustrates an exemplary custom routing table 300 generated by merging conference groups. Here, a first group 302 (Group 1—Main Conference Session) and a second group 304 (Group 2—Other Conference) are merged, the result being that the associated routing tables are merged to produce the custom routing table 300. The first group 302 is defined by a first table 306 which includes entities E₁-E₃ as sources and sinks. Similarly, the second group 304 is defined by a second table 308 which includes entities E₁ and E₄ as sources and sinks. As illustrated, the first table 306 and the second table 308 can overlap in that a user can be a member of both groups (302 and 304).

The merging of the first and second tables (306 and 308) creates the custom routing table 300. The disclosed architecture does not create separate routing tables for each group, but allows the creation of customized routing within the custom routing table 300 by turning on connections on and off via the flags (F) using rulesets. Each entity can be a source and each entity can be a sink; thus, the custom routing table 300 includes rows and columns for each session entity (E) the intersection of each of which is a flag that controls the connection.

Relative to the custom routing table 300, the first and second tables (306 and 308) become virtual subtables for managing the first and second groups separately. This is accomplished by the rulesets. For example, associated with the now first virtual table 306ᵥ in the custom routing table 300 is a first ruleset (not shown) that controls the state of the flags for the first virtual subtable 306. Associated with the now second virtual subtable (established by table source and sink elements E₁ and E₄, and associated flags F₁₁, F₁₄, F₄₁ and F₄₄) in the custom routing table 300 is a second ruleset (not shown) that controls the state of the flags for the second virtual subtable 308. Additionally, multiple rulesets can be applied to a single group.

The rulesets form the metadata (or state) of the conference connection matrix (how sources and sinks within a group are connected). In the end, all conference groups are combined to form the single custom routing table 300 for the conference. Additionally, as described above, access and permission rights on the conferencing server can be managed. Moreover, a source/sink connection can be terminated (via the associated flag) by modifying the associated ruleset if the service agreement is not honored or has completed (e.g., after playing an announcement or advertisement) without affecting the rest of the conference. This can be associated with email groups, contact lists, corporate associations, or a set of roles, for example.

As is described in examples provided hereinbelow, the flags can include state related to Allowed (A) (a connection is allowed between source and sink in anyone the conference groups), Not Allowed (NA) (a connection is not allowed between source and sink in anyone the conference groups), and No Information in any group (NI) (no information is available about the source and sink connection in any of the group). An entity in the Source column that maps to itself in the Sink row will have an NA flag. In one implementation, an entity in the Source column that maps to a different entity in the Sink row can be one of all three of the flag states. In an alternative implementation, loopback is allowed. It is to be understood, however, that these are just two examples, and should not be construed as limiting in any way, since other methods can be employed.

Consider a User A dialing into a conference hosted on audio/video (A/V) conferencing server with Users B and C. If User A needs to access some services, User A can press a key on a phone and an auto-attendant can be connected by allowing User A to subscribe to an Auto-Attendant group. The User A can be taken off the main conference or can remain in the main conference. Other users who are in the conference cannot listen to the conversation going between the User A and the auto-attendant. The User A can close this custom conference occurring with the auto-attendant by unsubscribing from the auto-attendant group. The following illustrates the resulting single custom routing table created from merging of the group tables.

Group 1 Regular Conference

| | Sink | | |
|---|---|---|---|
| Source | User A | User B | User C |
| User A | NA | A | A |
| User B | A | NA | A |
| User C | NA | A | NA |

Group 2 User A: Auto-Attendant

Sink

| Source | User A | Auto-Attendant |
|---|---|---|
| User A | NA | A |
| Auto-Attendant | A | NA |

Custom Routing Table for Custom Conference Group

| | Sink | | | |
|---|---|---|---|---|
| Source | User A | User B | User C | Auto-Attendant |
| User A | NA | A | A | A |
| User B | A | NA | A | NI |
| User C | NA | A | NA | NI |
| Auto-Attendant | A | NI | NI | NA |

The example above shows the two conferences groups (Regular Conference and User A: Auto-Attendant) that are present in the now single Custom Conference Group. Both group matrices are combined to form the single custom routing table for the entire conference. As illustrated in FIG. 3, the custom routing table 300 can extend to N rows and N columns with corresponding flags (FNN).

It is possible for a source/sink to be a member of two or more groups (User A in the above example belongs to both groups) with each group governed by a separate ruleset. In the actual routing table, if there is a connection allowed between a source and sink in any one conference group, that source and sink is connected in the final custom routing table.

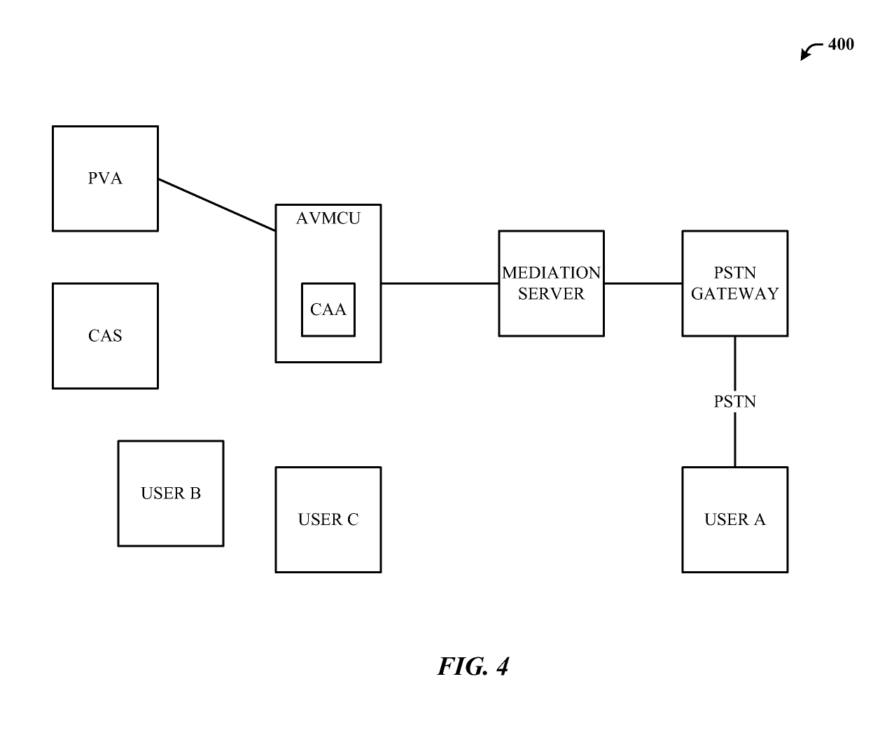

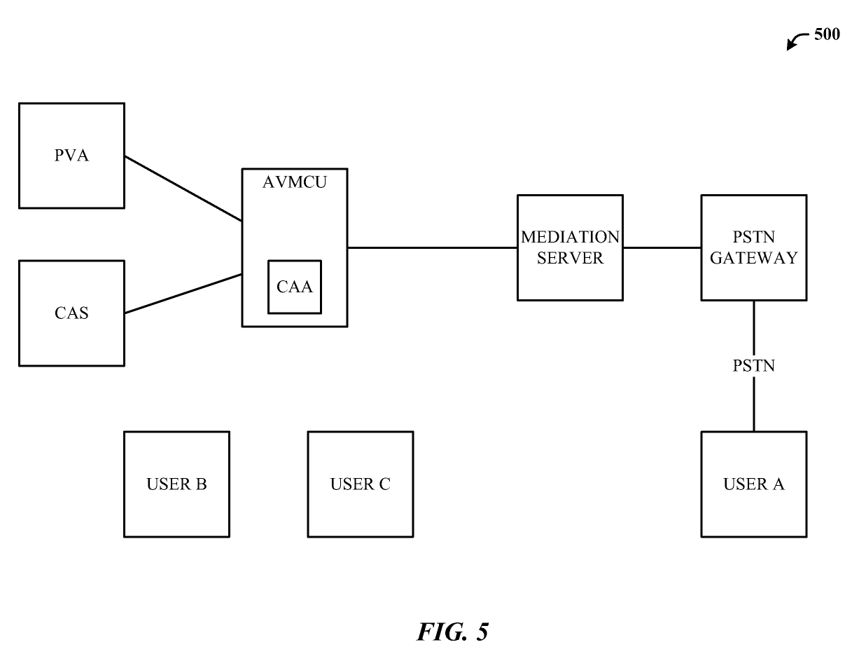

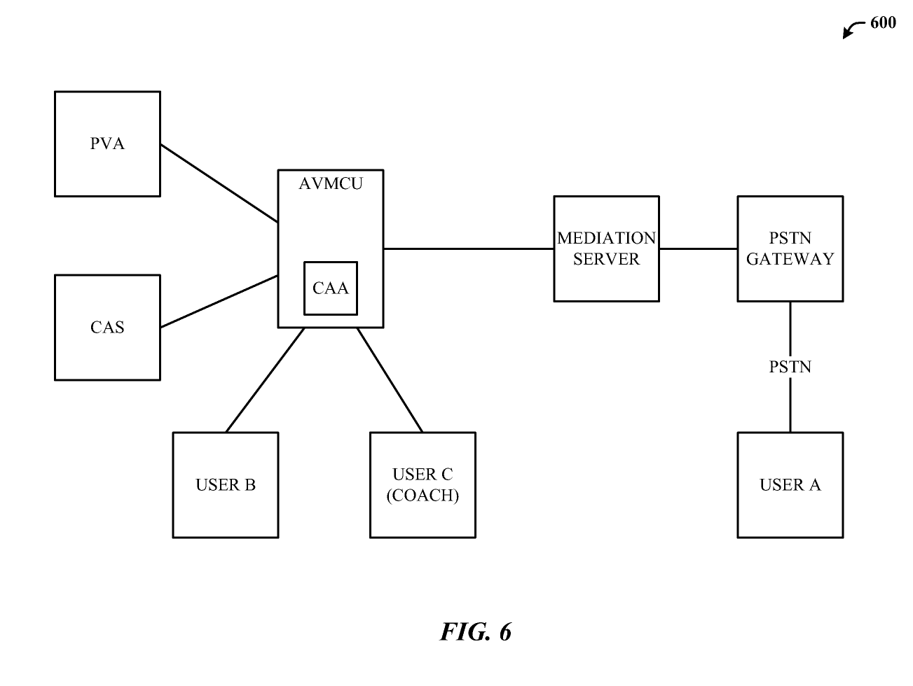

Following is a series of examples further illustrating the flexibility and granular control provided by the disclosed architecture. Ultimately, the conference groups of FIG. 4 and FIG. 5 are combined into a custom conference group in FIG. 6.

FIG. 4 illustrates a conference system 400 that employs the use of a personal virtual assistant (PVA) group. User A wants to join in the conference via the PSTN. A call from User A is placed over the PSTN to a PSTN gateway, and from the gateway to a mediation server. The mediation server forwards the call to an audio/video media control unit (AVMCU). The AVMCU employs a conference auto-attendant (CAA) to connect a PVA agent to User A for this conference. This connection is DTMF (dual-tone multi-frequency) enabled; thus, DTMF tones received from User A are forwarded to the PVA. Audio packets are still routed to/from the PVA. Applications can selectively mute the audio channel (DTMF will still flow to the PVA when then channel is muted). The following routing table is created for this group.

Group 1: PVA Group (N to N), DTMF enabled

Sink

| Source | User A (Mediation Server) | PVA |
|---|---|---|
| User A (Mediation Server) | NA | A |
| PVA | A | NA |

Other entities User B, User C and CAS (conference announcement service) will be addressed in the following figures.

FIG. 5 illustrates a conference system 500 that employs the use of a conference announcement service group. The CAA detects that the AVMCU needs to call User B. At this time, User A is listening to music on hold (the connection with the PVA is still on in case User A presses a digit (e.g., the “#” symbol)). As soon as someone else joins the conference, the CAS can play an announcement to the entire group members indicating that another entity has joined the conference. Note that all entities that need to listen to the CAS belong to one group (there is no need to create a separate group per CAS-client connection; just one group for each CAS is sufficient).

Group 2: CAS Group (1 to N)

Sink

| Source | CAS | User A (Mediation Server) |
|---|---|---|
| CAS | NA | A |
| User A (Mediation Server) | NA | A |

FIG. 6 illustrates a conference system 600 that employs the use of a conference announcement service group. User B is connected to this call such that User B and User A can hear and speak to each other. User B does not know about the PVA and CAS. User B also needs some assistance from his coach User C such that User C can listen to User A and User B, but can only talk to User B.

Group 3: Coach Agent Group (N to N)

Sink

| Source | User B | User C |
|---|---|---|
| User B | NA | A |
| User C | A | NA |

Group 4: Default Group (N to N)

| | Sink | | |
|---|---|---|---|
| Source | User A (Mediation Server) | User B | User C |
| User A (Mediation | NA | A | A |
| Server) | | | |
| User B | A | NA | A |
| User C | NA | NA | NA |

Combining all these tables (from PVA, CAS, and Coaching), results in the following routing table:

Group 5: Combined Conference Group - Custom Routing Table

| | Sink | | | | |
|---|---|---|---|---|---|
| | User A | | | | |
| Source | (Mediation Server) | User B | User C | CAS | PVA |
| User A | NA | A | A | NA | A |
| (Mediation | | | | | |
| Server) | | | | | |
| User B | A | NA | A | NI | NI |
| User C | NA | A | NA | NI | NI |
| CAS | A | NI | NI | NA | NI |
| PVA | A | NI | NI | NI | NA |

The flags for each to the connections are provided in the custom routing table. Note that an application can remove the CAS group after User A is connected to User B (the default group).

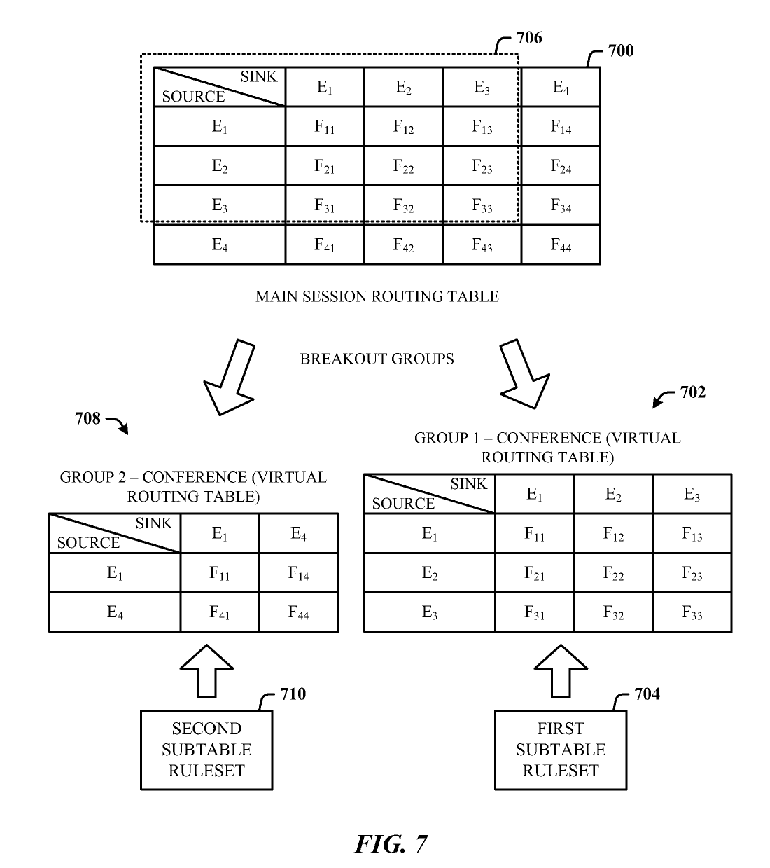

FIG. 7 illustrates an exemplary main session routing table 700 from which virtual routing subtables can be defined and enabled in support of breakout groups. Here, the main session routing table 700 includes entities (E) which can be sources and sinks, and the flags (F) that facilitate connecting the sources and the sinks. During the main conference, one or more breakout sessions can be created. A first group (GROUP 1) includes the entities E₁-E₃, and has an associated first group routing subtable 702. The first group subtable 702 is shown in the main session table 700 as being bounded by the dotted line 706. The flags (F) of the first group routing subtable 702 are managed by a first ruleset 704 that turn the flags off or on based on the current user state.

Similarly, a second group (GROUP 2) includes the entities E₁ and E₄, and has an associated second group routing subtable 708. The second group subtable 708 includes the entities E₁ and E₄ in the source column and entities E₁ and E₄ in the sink row in the main session table 700. The flags (F) of the second group routing subtable 708 are managed by a second ruleset 710 that turns the flags (F₁₁, F₁₄, F₄₁ and F₄₄) off or on based on the current user state. The virtual routing subtables (702 and 708) are shown separate from the main routing table 700 for illustration purposes only. In practice, no separate routing subtables are created.

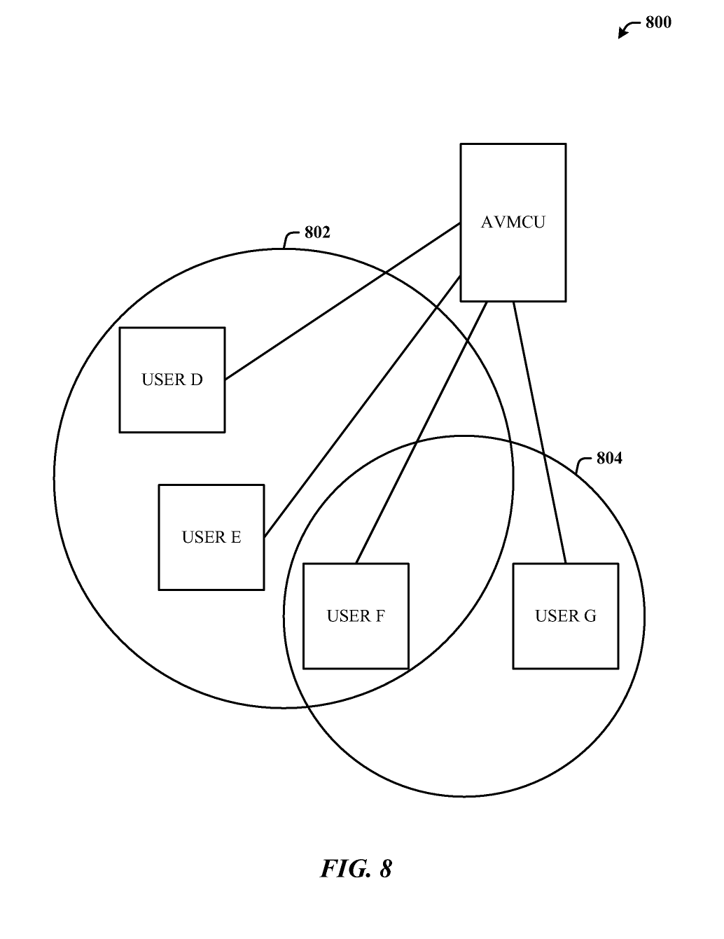

FIG. 8 illustrates a system 800 that employs subtable for conferencing breakout rooms. User D, User E, and User F are in a regular conference defined by a circle 802. User F is talking to User G, as well, in a breakout room defined by a circle 804. The default group contains User D, User E and User F. User F and G have the breakout group created for a private audio/video chat.

Default Group (N to N) - Main Routing table

| | Sink | | |
|---|---|---|---|
| Source | User D | User E | User F |
| User D | NA | A | A |
| User E | A | NA | N |
| User F | A | A | NA |

Breakout Room Group (N to N) - Breakout Routing Table

Sink

| Source | User F | User G |
|---|---|---|
| User F | NA | A |
| User G | A | NA |

The combined custom routing table is the following.

Sink

| Source | User D | User E | User F | User G |
|---|---|---|---|---|
| User D | NA | A | A | NI |
| User E | A | NA | A | NI |
| User F | A | A | NA | A |
| User G | NI | NI | A | NA |

Note that it is possible for User F to change direction within one group as receiver only.

Following is a description of a subscription service (e.g., video). User H, User I, and User J are in a regular conference. User I wants to subscribe to User J's video. User I is now getting two video streams from the AVMCU: one for the overall conference (based on a primary/secondary video source) and one always from User J. User H, User I, and User J are in the default group as sources and sinks, and User I and User J are in subscription video group such that User J is the only source and User I is the only sink in that group. Assume that currently the primary video source is User H and secondary video source is User I. User H, the primary video source, sees User I, a secondary video source. User J see User H (the primary video source). User I has two video streams. One video stream is from User H (the primary video source) and the other stream is show User J (the subscribed video source).

The groups in this example are the following.

Default Group - Main Session Routing Table

| | Sink | | |
|---|---|---|---|
| Source | User H | User I | User J |
| User H | NA | A | A |
| User I | A | NA | NA |
| User J | NA | NA | NA |

Subscribed video Group - Routing Table

Sink

| Source | User I | User J |
|---|---|---|
| User I | NA | NA |
| User J | A | NA |

The combined video routing table will look as follows.

### Combined Video Routing Table

| | Sink | | | |
|---|---|---|---|---|
| Source | User H | User I | User J | User on Subscription video |
| User H | NA | A | A | NA |
| User I | A | NA | NA | NA |
| User J | NA | NA | NA | A |

Note that an application can add a new source for User J, if User J is sending CIF (common intermediate format) in the Default Group and video signals (e.g., VGA—video graphics array) to User I on the subscription video channel.

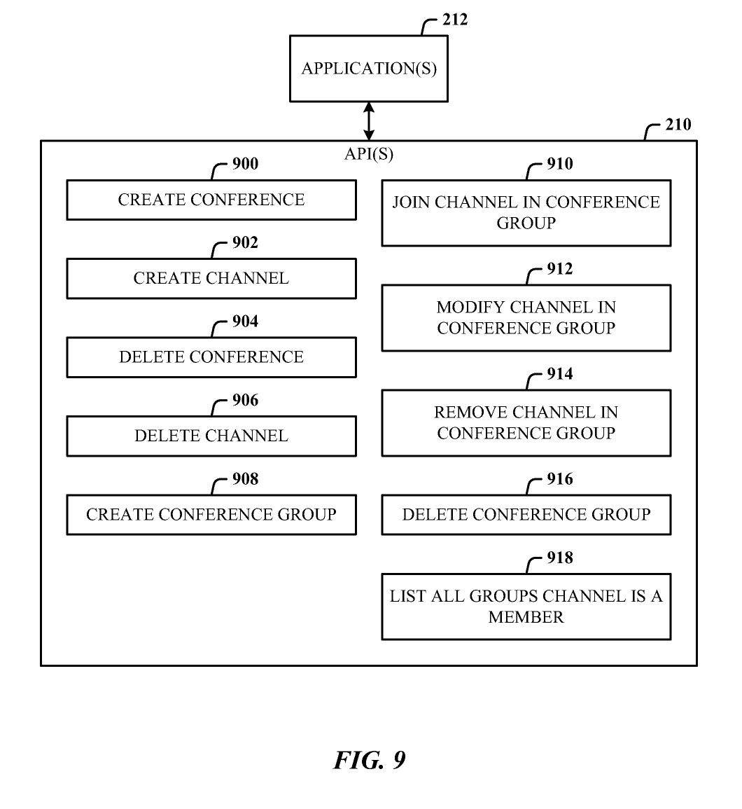

FIG. 9 illustrates exemplary APIs 210 that can be provided to allow applications 212 to access and interact with functionality of the disclosed architecture. APIs that expose group creation, management, and deletion to upper layer application(s) 212 are provided. The functional behavior of each API is described as follows.

An upper layer application 212 creates a conference using a create conference API 900 (RTPConference) whenever a new call (P2P (peer-to-peer) or conference) is initiated. A conference group can be created at this time. The conference group is referred to as the Default Group. In one implementation, the Default group cannot be deleted by applications unless the conference is deleted. In an alternative implementation, the Default Group can be deleted under other conditions. In one implementation, the Default Group has DS(dominant speaker)/VS(video switching) notification enabled and DTMF disabled. In an alternative implementation, DS/VS notification can be in other groups as well.

An upper layer application 212 uses a create channel API 902 (RTPChannel) to create a new channel (source or sink) when a new channel needs to be added in conference. A group can be assigned to the newly created channel with the default group.

An upper layer application 212 can use a delete conference API 904 (RTPConference) when the whole call (P2P or conference) is terminated. All the groups (e.g., default groups and customized groups) that are created by the API 904 can be deleted.

An upper layer application 212 can use a delete channel API 906 (RTPChannel) to delete a channel when the channel (source or sink) is no longer required in the conference. All the joined groups that this channel belongs to can be removed.

Whenever an application 212 detects that the channel needs to be part of a special group, the application 212 via a create conference group API 908 creates a new group. The application 212 specifies whether the group will have additional functionalities such as DS/VS notification and/or DTMF routing enabled or not. A default group (created at this time to RTPConference creation) can have DS/VS notification and DTMF routing disabled.

When an application 212 adds a channel to a group, a join channel API 910 is employed to a group (see in scenarios), and the application 212 adds the channel (RTPChannel) to an already existing group via the API 910. The application 212 needs to specify the direction in which the channel needs to be included in the group (e.g., send, receive, both or none). By default, the direction is none. The routing for the conference is recalculated before returning.

If an upper layer application 212 needs to modify a channel (RTPChannel) direction within an already joined group, the application 212 via a modify channel API 912 modifies the channel direction in the group. The application specifies the direction in which the channel needs to be included in the group (e.g., send, receive, both or none). A successful call modifies the direction, while a failed call will keep the old direction. The routing for the conference is recalculated before returning.

If an upper layer application 212 needs to remove a channel (RTPChannel) from an already joined group, the application 212 employs a modify channel API 914 to remove the channel from the group. The routing for the conference is recalculated before returning. A failed call will not change the existing the routing table.

If an upper layer application 212 needs to delete a conference group (RTPConferenceGroup), the application 212 uses a remove group API 916 to delete the conference group (RTPConferenceGroup). All the channels are removed from the conference group. The routing for the conference is recalculated before returning. A failed call will not change the existing the routing table.

If an upper layer application 212 needs to know all the groups that a channel (RTPChannel) has joined, the application 212 can employ a list all groups channel API 918 to obtain the reference of all the conference groups (RTPConferenceGroup) the channel (RTPChannel) has joined.

Following is a brief but non-exhaustive summary of some of the capabilities of the disclosed conferencing architecture. An API can be exposed to an application to create groups with/without additional functionalities such as DS/VS notifications and with/without DTMF routing, and within the conference. An API is exposed to an application to join the group in any direction and to allow channels to leave. Channels are allowed to leave default group in any state, as long as the default group is not deleted. A channel with no group is not part of any mix. Channels are allowed to be members of various groups in all possible directions.

Channels are allowed to modify the associated connection within the group after joining. This is facilitated by exposing an API to upper applications that allow a change in directions within groups. Channels are allowed to see all the groups that this channel has joined. This is facilitated by exposing an API to upper applications for finding all the groups that a particular channel has joined.

Additional functionalities such as DV and VS notification per group can be performed. If a DS/VS notification is set on a channel, events are raised whenever there is DS/VS notification on that group only.

DTMF routing can be disabled on the default group. Only groups created with enabled DTMF routing (PVA group) can route DTMF. Enabling DTMF routing on the default group can be facilitated by exposing an API to an upper level application.

Security can be provided such that a channel can only modify the connection of itself and only within a group. The default group can be managed so as to not be deleted except by deleting the conference.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

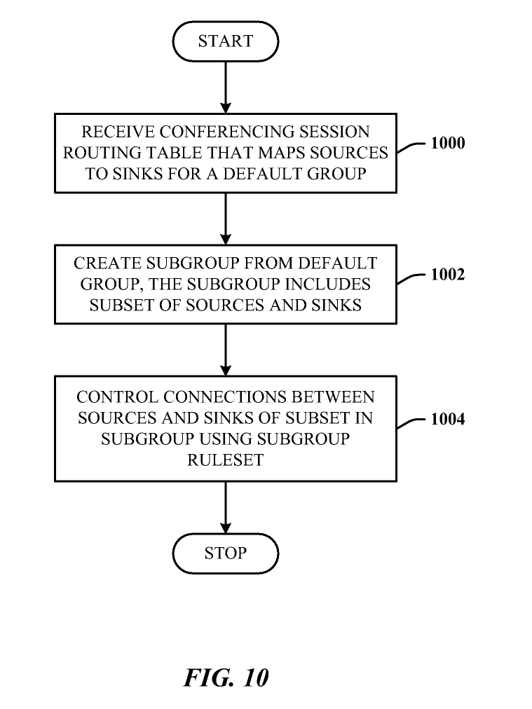

FIG. 10 illustrates a method of managing a conferencing session. At 1000, a conferencing session routing table is received that maps sources to sinks for a default group. At 1002, a subgroup is created from the default group, the subgroup includes a subset of the sources and the sinks. At 1004, connections between the sources and the sinks of the subset in the subgroup are controlled using a subgroup ruleset.

The method can further comprise applying a ruleset to the subgroup that manages security permissions, and managing a source/sink connection based on a media service agreement. The method can further comprise creating a new subgroup from the default group, the new subgroup includes a source and sink that is not a member of the default group. The method can further comprise merging a group into the default group by adding a subtable of the subgroup to the session routing table to create a final routing table.

Other acts of the method can include defining the connections of the subgroup via a subtable where flags controlled by the ruleset make (complete) or break (disable) the connections between the sources and the sinks to route conference media, and creating or deleting the subgroup via an external application. The method can further comprise modifying a subtable that defines connections in the subgroup via a programmable interface.

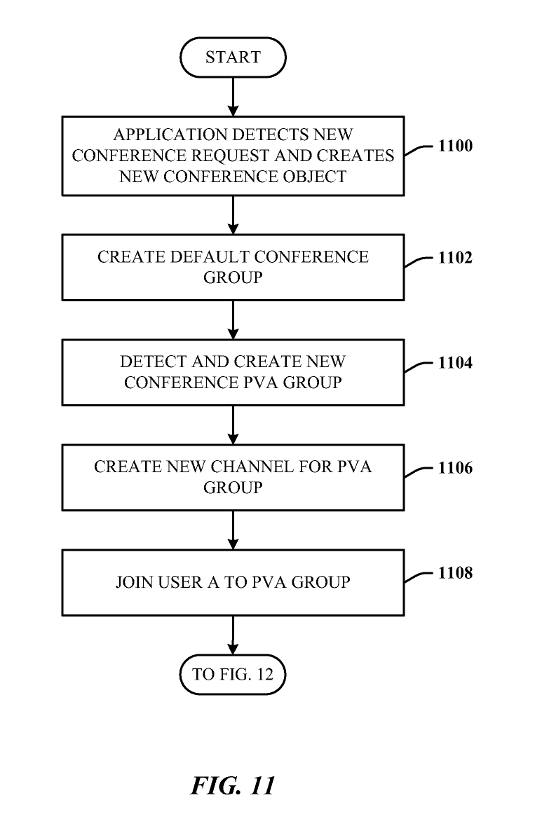

FIG. 11 illustrates an exemplary method for path execution when employing a personal virtual assistant. At 1100, an upper layer application (e.g., AVMCU) detects a new conference request and creates a conference object. A default group is created internally. At 1102, the upper layer application creates a new channel for User A. The User A is added to the default group in both directions (send, receive) and the routing table is re-calculated. At 1104, the upper layer application detects a need to create a new conference group (as the CAA instructs the AVMCU to add the PVA) and creates a new conference group without DS/VS notification, but with DTMF routing enabled. The new conference PVA group is created. At 1106, the upper layer application creates a new channel for the PVA, removes the PVA from the default group, and joins PVA in both directions (send and receive) in the PVA group. The routing table is re-calculated. At 1108, the upper layer application joins User A to the PVA Group in both directions. The routing table is re-calculated. The complete routing table is now complete for the PVA Scenario.

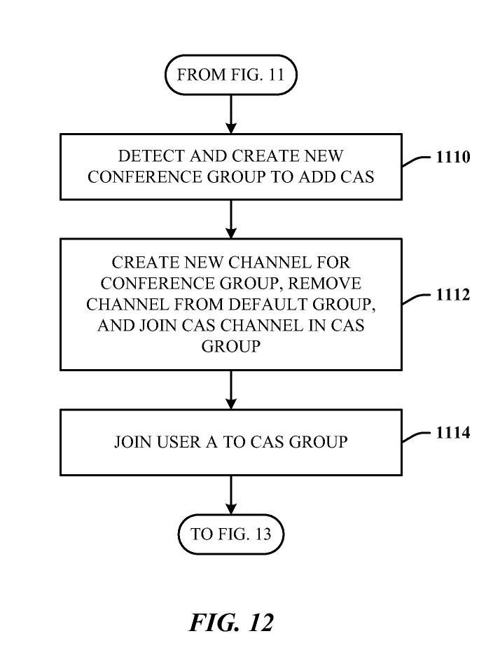

FIG. 12 illustrates an exemplary method for path execution when further employing a conference announcement service. Continuing with the flow chart of FIG. 11, at 1110, the upper layer application detects a need to create a new conference group as CAA instructs the AVMCU to add CAS to the conference. The application creates a new conference group without DS/VS notification and without DTMF routing. A new conference CAS group is created. At 1112, the upper layer application creates a new channel for the CAS, removes the channel from the default group, and joins the CAS channel as source-only in the CAS group. The routing table is re-calculated. At 1114, the upper layer application joins User A to the CAS group in a sink direction. The routing table is re-calculated. Note that in the case where multiple channels are to be connected to the CAS, there is no need to create new groups—just add the channel to the same group. The routing table is now complete for the CAS scenario.

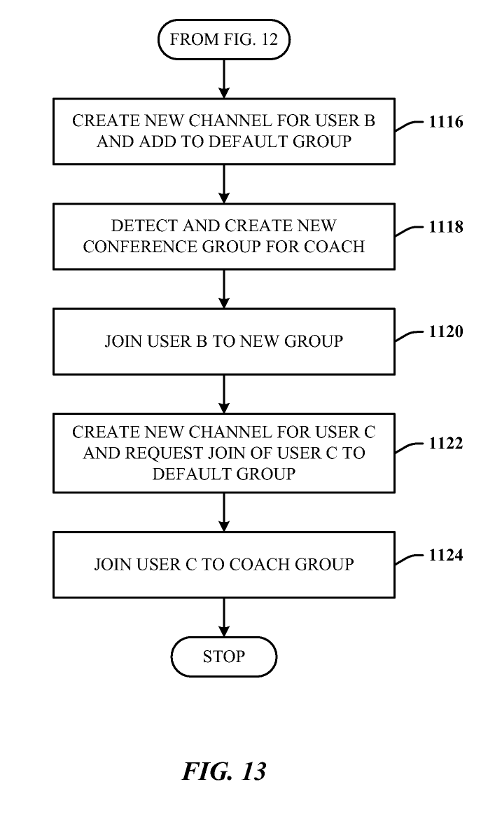

FIG. 13 illustrates an exemplary method for path execution when further employing a coach scenario to the method of FIG. 11 and FIG. 12. At 1116, the upper layer application creates a new channel for a User B (agent). User B is added to the default group in both directions and the routing table is re-calculated. Note that the User A was already in the default group. If required, the upper layer application can remove User A from the CAS group. At 1118, the upper layer application detects a need to create a new conference group as User B wants to engage the Coach, and creates a new conference group without DS/VS notification and DTMF routing. The new conference group (Coach Group) is created internally. At 1120, the upper layer application joins User B to the new group in both directions. The routing table is re-calculated. At 1122, the upper layer application creates a new channel for User C (Coach) and the application requests the addition of User C as sink-only to the default group. User C is added to the default group in the receive direction only (sink). The routing table is re-calculated. At 1124, the upper layer application joins User C in the Coach Group in both directions. The routing table is re-calculated. The routing table is now complete for the coaching scenario.

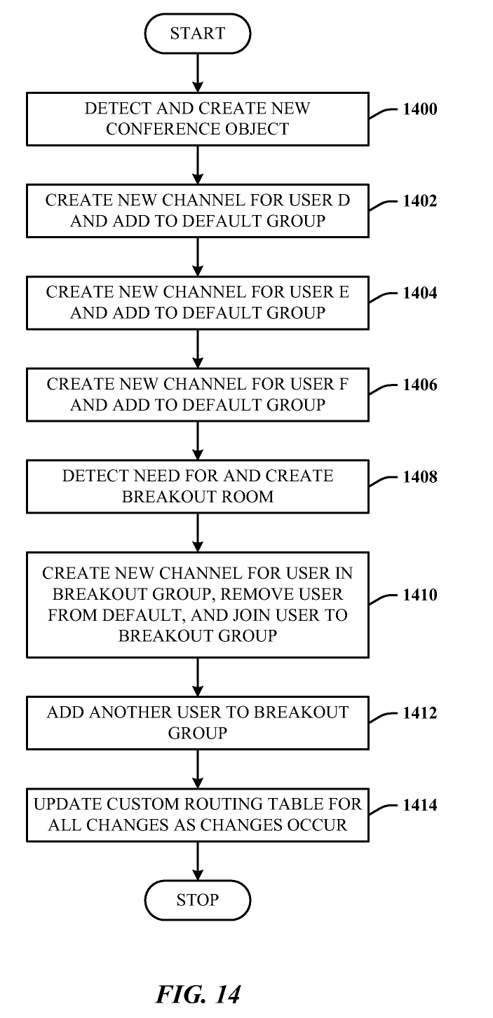

FIG. 14 illustrates a method of processing breakout rooms for a conferencing session. At 1400, an upper layer application detects a new conference request and creates a conference object. The default conference group is then created. At 1402, the upper layer application creates a new channel for User D. User D is added to the default group in both directions. The routing table is re-calculated. At 1404, the upper layer application creates a new channel for User E. User E is added to the default group in both directions, and the routing table is re-calculated. At 1406, the upper layer application creates a new channel for User F. User F is added to the default group in both directions. The routing table is re-calculated. At 1408, the upper layer application detects that User F needs a breakout room with User G. The application creates a new conference group (Breakout) with DS/VS notification and without DTMF routing. At 1410, the upper layer application creates a new channel for User G, removes User G from the default group and joins User G in the breakout group. The routing table is re-calculated. At 1412, the upper layer application adds User F to the breakout group. The routing table is re-calculated. The routing table is now complete for the breakout room scenario.

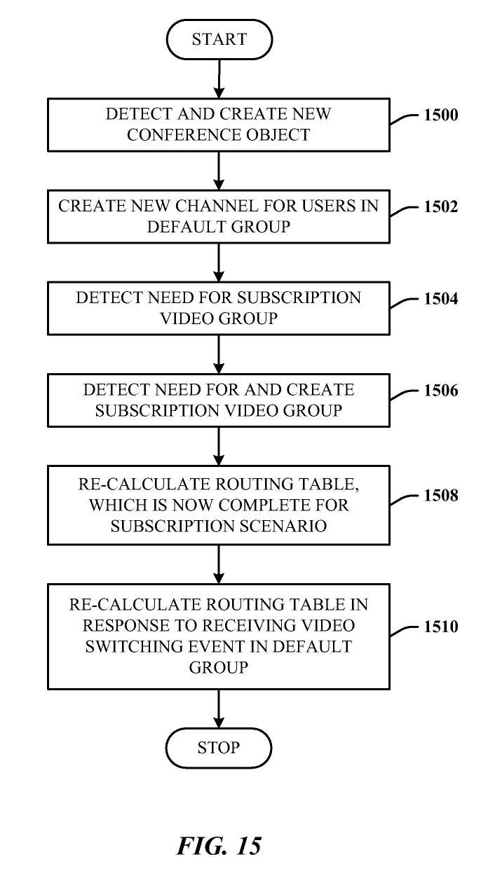

FIG. 15 illustrates a method of processing video subscription for a conferencing session. At 1500, the upper layer application detects a new conference request and creates a conference object. The default group is internally created. At 1502, the upper layer application creates a new channel for User H, User J and User I in the default group. At 1504, the upper layer application detects that User I needs a subscription video group User J. The application creates a new conference group (subscription video group) without DS/VS notification and without DTMF routing. At 1506, the upper layer application adds User J (source only) and User I (sink only) in the subscription video group. The upper layer application needs to create a new channel for User I for the sink-only case. There is also a possibility that User I may subscribe to User J video in VGA mode (while User J is generally sending CIF in the conference). In this case, the upper layer application needs to create a new channel for User J that can add VGA video to the subscribed video group. At 1508, the routing table is re-calculated, and is now complete for the subscription video scenario. At 1510, upon getting a video switching event in the default group, the routing table is re-calculated.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

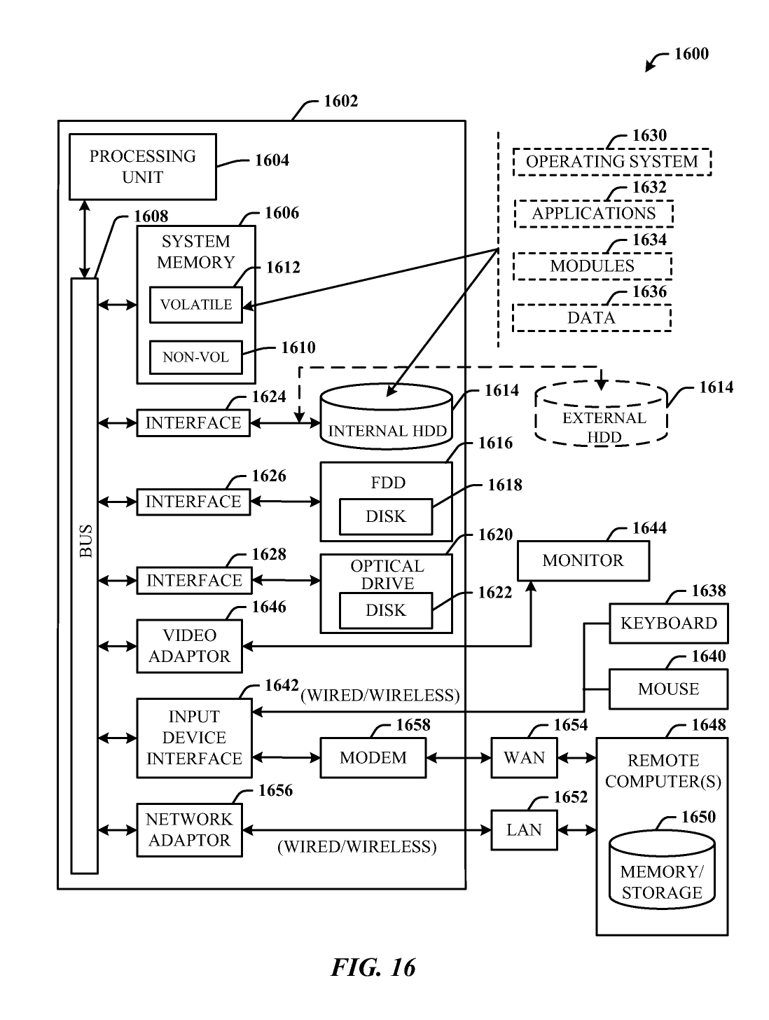

Referring now to FIG. 16, there is illustrated a block diagram of a computing system 1600 operable to execute the disclosed custom routing table architecture. In order to provide additional context for various aspects thereof, FIG. 16 and the following discussion are intended to provide a brief, general description of a suitable computing system 1600 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 16, the exemplary computing system 1600 for implementing various aspects includes a computer 1602 having a processing unit 1604, a system memory 1606 and a system bus 1608. The system bus 1608 provides an interface for system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 can include non-volatile memory (NON-VOL) 1610 and/or volatile memory 1612 (e.g., random access memory (RAM)). A basic input/output system (BIOS) can be stored in the non-volatile memory 1610 (e.g., ROM, EPROM, EEPROM, etc.), which BIOS are the basic routines that help to transfer information between elements within the computer 1602, such as during start-up. The volatile memory 1612 can also include a high-speed RAM such as static RAM for caching data.

The computer 1602 further includes an internal hard disk drive (HDD) 1614 (e.g., EIDE, SATA), which internal HDD 1614 may also be configured for external use in a suitable chassis, a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as a DVD). The HDD 1614, FDD 1616 and optical disk drive 1620 can be connected to the system bus 1608 by a HDD interface 1624, an FDD interface 1626 and an optical drive interface 1628, respectively. The HDD interface 1624 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1612, including an operating system 1630, one or more application programs 1632, other program modules 1634, and program data 1636. Where the computer 1602 hosts a web-based conferencing system, the one or more application programs 1632, other program modules 1634, and program data 1636 can include the routing table 102, session members 104, the customization component 106, the group 108, the virtual subtable 110, the rules component 202, the subtable ruleset 204, the access component 206, the service component 208, the API(s) 210 (and specific APIs 900-918), and the application(s) 212, for example.

All or portions of the operating system, applications, modules, and/or data can also be cached in the volatile memory 1612. It is to be appreciated that the disclosed architecture can be implemented with various commercially available operating systems or combinations of operating systems.

A user can enter commands and information into the computer 1602 through one or more wire/wireless input devices, for example, a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces such as a parallel port, IEEE 1394 serial port, a game port, a USB port, an IR interface, etc.

A monitor 1644 or other type of display device is also connected to the system bus 1608 via an interface, such as a video adaptor 1646. In addition to the monitor 1644, a computer typically includes other peripheral output devices (not shown), such as speakers, printers, etc.

The computer 1602 may operate in a networked environment using logical connections via wire and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wire/wireless connectivity to a local area network (LAN) 1652 and/or larger networks, for example, a wide area network (WAN) 1654. Such LAN and WAN networking environments are commonplace in offices and companies, and facilitate enterprise-wide computer networks, such as intranets, all of which may connect to a global communications network, for example, the Internet.

When used in a LAN networking environment, the computer 1602 is connected to the LAN 1652 through a wire and/or wireless communication network interface or adaptor 1656. The adaptor 1656 can facilitate wire and/or wireless communications to the LAN 1652, which may also include a wireless access point disposed thereon for communicating with the wireless functionality of the adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wire and/or wireless device, is connected to the system bus 1608 via the input device interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented conference management system, comprising:
a routing table of a main conferencing session for defining connections between session entities for communication of media; and
a customization component for managing a group of the session entities in the main conferencing session based on a virtual subtable defined in the routing table.

2. The system of claim 1, further comprising a rules component for generating a subtable ruleset for the subtable that maps connections between the group entities for communication of media.

3. The system of claim 2, wherein the rules component is exposed to an external application via which the subtable ruleset is generated.

4. The system of claim 2, further comprising an access component for managing access to the conferencing session via the rules component by creating rules that manage the access.

5. The system of claim 1, further comprising a service component for managing a source/sink link between the group entities according to a service agreement, the link managed by modifying a ruleset for the virtual subtable.

6. The system of claim 1, wherein a session entity belongs to more than one group.

7. The system of claim 1, wherein the customization component removes a source/sink link of entities of the group without affecting the main conferencing session.

8. A computer-implemented conference management system, comprising:
a main routing table of a main conferencing session for defining connections between source entities and link entities for communication of media;
a customization component for creating a group from the entities in the main conferencing session based on a virtual subtable defined in the routing table; and
a rules component for generating a subtable ruleset for the subtable that maps connections between the group entities for communication of media.

9. The system of claim 8, further comprising an access component for managing access to the conferencing session via the subtable ruleset.

10. The system of claim 8, further comprising a service component for managing a source/sink link between the group entities according to a service agreement, the link managed by modifying a ruleset for the virtual subtable.

11. The system of claim 8, wherein a main session entity belongs to the main conferencing session, a group, or the main session and the group.

12. The system of claim 8, wherein the customization component removes a source/sink link of entities of the group without affecting the main conferencing session.

13. A computer-implemented method of managing a conferencing session, comprising:
receiving a conferencing session routing table that maps sources to sinks for a default group;
creating a subgroup from the default group, the subgroup includes a subset of the sources and the sinks; and
controlling connections between the sources and the sinks of the subset in the subgroup using a subgroup ruleset.

14. The method of claim 13, further comprising applying a ruleset to the subgroup that manages security permissions.

15. The method of claim 13, further comprising managing a source/sink connection based on a media service agreement.

16. The method of claim 13, further comprising creating a new subgroup from the default group, the new subgroup includes a source and sink that is not a member of the default group.

17. The method of claim 13, further comprising merging a group into the default group by adding a subtable of the subgroup to the session routing table to create a final routing table.

18. The method of claim 13, further comprising defining the connections of the subgroup via a subtable where flags controlled by the ruleset make or break the connections between the sources and the sinks to route conference media.

19. The method of claim 13, further comprising creating or deleting the subgroup via an external application.

20. The method of claim 13, further comprising modifying a subtable that defines connections in the subgroup via a programmable interface.
